(19) United States
(12) Patent Application Publication
(10) Pub. No.: US 2005/0188034 A1
(43) Pub. Date: Aug. 25, 2005

(54) Electronic message management system with header analysis

(75) Inventors: Elias Israel, Kirkland, WA (US); Kee Hinckley, Winchester, MA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: MessageGate, Inc.

(21) Appl. No.: 11/036,916

(22) Filed: Jan. 14, 2005

Related U.S. Application Data
(60) Provisional application No. 60/536,910, filed on Jan. 16, 2004.

(51) Int. Cl. G06F 15/16

(52) U.S. Cl. 709/206

(57) ABSTRACT

An electronic message management system, including in one embodiment, header analysis criteria with associated scores, as well as analysis and scoring methods, is disclosed and described herein.

### RELATED APPLICATIONS

The present application is a non-provisional application of provisional applications 60/536,910, entitled “Contextual Header Analysis For Messaging Routing Validation”, filed on Jan. 16, 2004. The present application claims priority to said provisional application, and incorporates its specifications by reference, to the extent the '910 specification is consistent with the specification of this non-provisional application.

### TECHNICAL FIELD

The present invention relates generally, but not limited to, the fields of data processing and data communication. In particular, the present invention relates to the control of electronic messages, e.g. offensive or unwanted electronic messages, by analyzing the headers of the electronic messages.

### BACKGROUND

With advances in computing and networking technology, electronic messaging, such as email, has become ubiquitous. It is used for personal as well as business communication. However, in recent years, the effectiveness of electronic messaging is undermined due to the rise and proliferation of spam mails and viruses.

Large enterprises, such as multi-national corporations, handle millions of electronic messages each day, employing multiple geographically dispersed servers, to serve their far flung constituent clients. The problem of unwelcome or undesirable electronic messages is especially difficult for them.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates an overview of an electronic message management system, suitable for practicing the invention, in accordance with some embodiments;

FIG. 2 illustrates the mail management server of FIG. 1 in further detail, in accordance with some embodiments;

FIG. 3 illustrates a boundary mail server of FIG. 1 in further detail, in accordance with some embodiments;

FIG. 4 illustrates the operational flow between an external/internal mail sender and a boundary mail server, in accordance with some embodiments;

FIG. 5 illustrates a simplified example of organized/compiled header analysis criteria, in accordance with some embodiments;

FIG. 6 illustrates an overview of the generation of the organized/compiled header analysis criteria, in accordance with some embodiments; and

FIG. 7 illustrates the operational flow of the header analysis criteria compiler of FIG. 6, in accordance with some embodiments.

### DETAILED DESCRIPTION OF ILLUSTRATIVE EMBODIMENTS

Illustrative embodiments of the present invention include, but are not limited to, an electronic message management system, including e.g. a central mail management server, and a number of boundary mail servers, adapted to manage electronic messages through at least analysis of the headers of the electronic messages.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

The phrase “in one embodiment” is used repeatedly. The phrase generally does not refer to the same embodiment; however, it may. The terms “comprising”, “having” and “including” are synonymous, unless the context dictates otherwise. The term “server” may be a hardware or a software implementation, unless the context clearly indicates one implementation over the other.

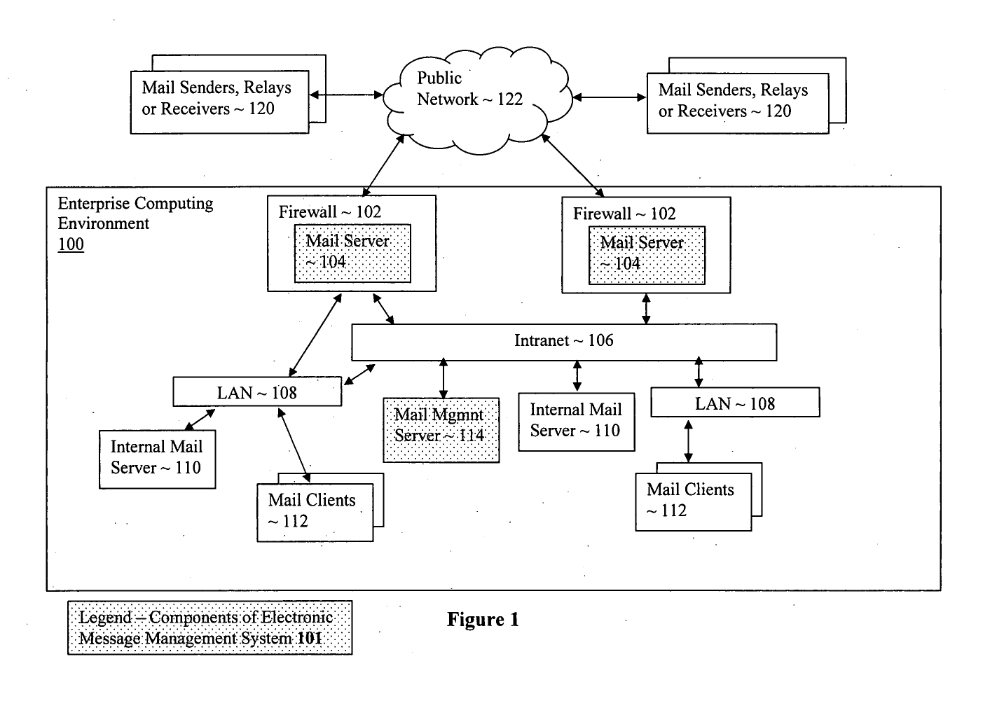

Referring now to FIG. 1, wherein an overview of an electronic message management system, in accordance with some embodiments, is shown. As will be apparent to those skilled in the art, the electronic message management system is particularly suitable for large enterprises, handling millions of electronic messages per day, utilizing numerous geographically dispersed servers. Since electronic mail is the most predominant form of electronic messages, for ease of understanding, the remaining descriptions will primary be presented in the context of electronic mail management. However, one skilled in the art will appreciate that the present invention may be practiced to manage all types of electronic messages, including but are not limited to electronic mails. Further, the present invention may be practiced in computing environment having other architectures.

As illustrated, for the embodiments, electronic message management system 101 includes a central mail management server 114 and a number of distributed mail servers 104. For the embodiments, distributed mail servers 104 are placed on a number of devices, such as firewalls 102, located at a number of boundary points of enterprise computing environment 100. In alternate embodiments, the mail servers need not be placed on the same machine as the firewall. The firewall machines may sit on separate hardware from the mail servers, just in front of them and modulating access to them by servers outside the enterprise computing environment 100. The zone into which the perimeter mail servers are placed is usually called a “DMZ” (demilitarized zone), and is typically reserved for those few boundary servers (e.g. email, http, etc.) that need to provide network services that connect directly to external clients on the Internet (e.g. email senders, web browsers, etc.). Accordingly, distributed mail servers 104, whether it is placed directly on the same hardware with the firewall, or on separate hardware behind the firewall, in a DMZ, may also be referred to as boundary mail servers 104. Further, for the embodiments, boundary mail servers 104 are operatively coupled to central mail management server 114, through e.g. Intranet fabric 106. Intranet fabric 106 represents a collection of one or more networking devices, such as routers, switches and the like, to provide the operative coupling between boundary mail servers 104 and mail management server 114.

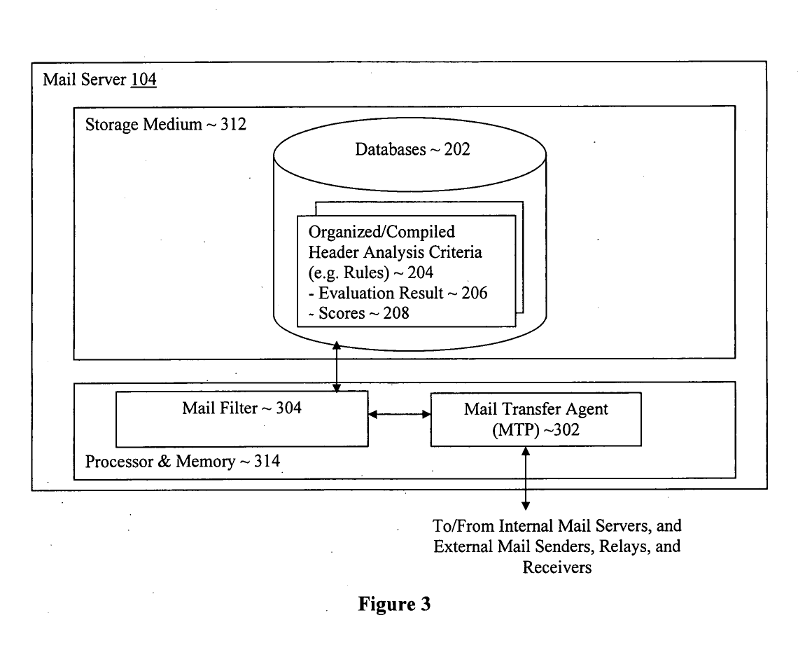

As will be described in more detail below, in various embodiments, boundary mail server 104 includes a mail transfer agent (MTA) component 302 and a mail filter component 304 (FIG. 3). In particular, MTA 302 is adapted to receive emails from electronic mail senders (which may be outside or within enterprise computing environment 100) using e.g. the Simple Mail Transfer Protocol (SMTP) and its extensions defined by the Internet Engineering Task Force (IETF) in [RFC2822] and related specifications, and mail filter component 304 is adapted to determine, and instruct MTA 302 on whether the received mails are to be accepted or rejected. Further, mail filter 304 is adapted to make the determination efficiently and consistently across enterprise computing environment 100, in accordance with the enterprise's email management policies. Still further, central mail management server 114 is employed to centrally manage the enterprise's electronic mail management policies. An example of a suitable MTA is Sendmail, available from Sendmail, Inc. of Emeryville, Calif., in particular, versions that support the Milter Application Programming Interface.

Continue to refer to FIG. 1, enterprise computing environment 100 is coupled to the external world, e.g. to various external mail senders, relays or receivers 120, through public network 122. External mail senders, relays or receivers 120 represent a broad range of these elements known in the art. Public network 122 may comprise one or more interconnected public networks, including but are not limited to the famous Internet.

Within enterprise computing environment 100, firewall 102 (including mail server 104 are coupled to other internal servers, such as the earlier described mail management server 114 and internal mail servers 110, and mail clients 112, through a number of internal networks, including but not limited to intranet 106 and local area networks 108.

In various embodiments, one of the internal servers, e.g. mail management server 114, may also be used as an analysis server, to facilitate analysis of various suspicious electronic mails by administrators of enterprise computing environment 100.

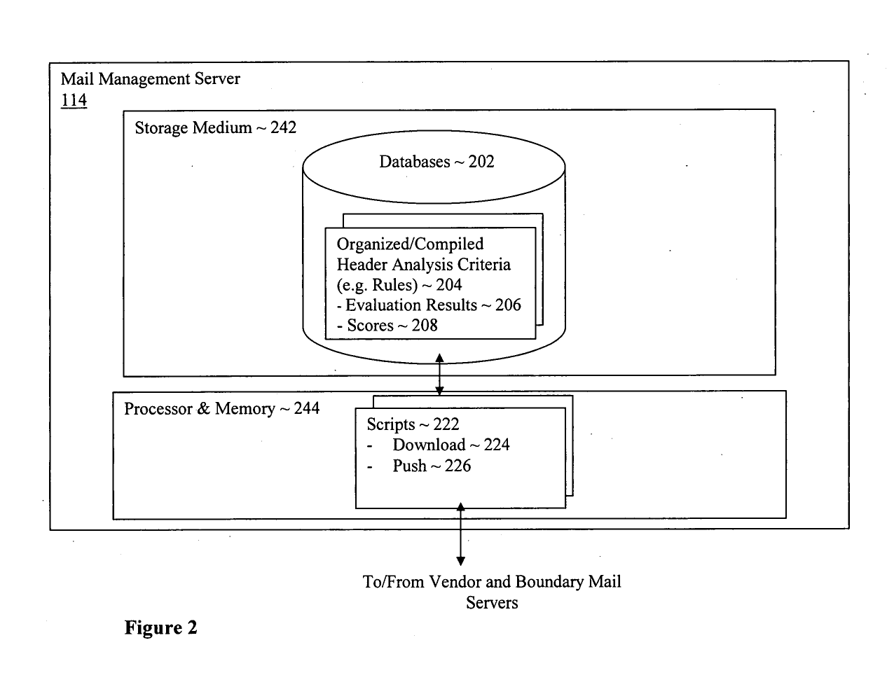

Referring now to FIG. 2, wherein mail management server 114 is illustrated in further detail, in accordance with various embodiments. As illustrated, for the embodiments, mail management server 114 includes one or more management databases 202 having stored therein a number of organized/compiled header analysis criteria 204, expressed e.g., into the form of rules, for analyzing a header of a received electronic message. Each header analysis criterion 204 specifies an evaluation to be performed for the header of the received electronic message.

In various embodiments, organized/compiled header analysis criteria 204 include header analysis criteria that check for signs of legitimacy and/or illegitimacy, which may include but are not limited to syntactical correctness/error, known bogus/counterfeit, or contradictory/inconsistent conditions. In various embodiments, organized/compiled header analysis criteria 204 may include independent and dependent header analysis criteria. An independent header analysis criterion is a header analysis criterion with no analysis dependency on any other header analysis criterion. In other words, the independent header analysis criteria may be evaluated at anytime. A dependent header analysis criterion is a header analysis criterion with one or more analysis dependency on one or more of the independent and other dependent header analysis criteria. An analysis dependency may itself depend on one or more of other independent and/or dependent header analysis criteria. In various embodiments, a dependent header analysis criterion is evaluated only after all its analysis dependencies have been resolved, e.g. the header analysis criteria, on which the header analysis criterion is dependent on, have all been evaluated.

In other words, for the illustrated embodiments, a header analysis criterion 204 may be specified without analysis dependency or with analysis dependency. For the embodiments, header analysis criteria 204 are organized/compiled by their interdependency, to facilitate their processing.

Additionally, in various embodiments, each header analysis criterion 204 may have an expected evaluation result. The expected evaluation results may include a positive evaluation result (e.g. Good), a non-positive evaluation result (e.g. Not Good), a negative evaluation result (e.g. Bad), a non-negative evaluation result (e.g. Not Bad), and an unable to determine result (e.g. Unknown).

Further, in various embodiments, each header analysis criteria 204 may also have an evaluation state, e.g. evaluation completed or evaluation not completed

Still further, for the illustrated embodiments, each header analysis criterion 204 may have one or more associated scores 208 to be accumulated into corresponding scoring metric(s) of the electronic message, which header is being evaluated, based at least in part of particular evaluation results of the header analysis criterion. Examples of the scoring metrics may include a positive scoring metric and a negative scoring metric.

In various embodiments, an electronic message, which header is being evaluated, is also characterized, e.g. spam or not spam, based at least in part on the accumulated scores for the scoring metrics. For example, an electronic message may be characterized as a spam or not a spam, based on whether the difference (i.e. the gap) between the positive and negative scoring metric exceeds or below a predetermined threshold.

For the illustrated embodiments, mail management server 114 also includes a number of scripts 222 to facilitate loading of the organized/compiled header analysis criteria 206 into management databases 202, and their distributions to boundary mail servers 104. In particular, in various embodiments, scripts 222 include a script 224 to download the organized/compiled header analysis criteria 206 into management databases 202 from a vendor/supplier, and a script 226 to push the most current version of management databases 202 onto boundary mail servers 104, allowing boundary mail servers 104 to operate more efficiently, without having to access management server 114 across the enterprise's internal network during operation.

In alternate embodiments, in lieu of a script to “push” the current version of management databases 202 onto boundary mail servers 104, scripts adapted to “pull” the current version from mail management server 114 may be provided to the boundary mail servers 104 instead.

Additionally, for the embodiments, mail management server 114 includes one or more persistent storage units (storage medium) 242, employed to stored management databases 202. Further, mail management server 114 includes one or more processors and associated non-persistent storage (such as random access memory) 244, coupled to storage medium 242, to execute scripts 222.

Referring now to FIG. 3, wherein a boundary mail server 104 is illustrated in further detail, in accordance to various embodiments. As alluded to earlier, mail server 104 includes a local copy of management databases 202. Further, for the embodiments, mail server 104 includes MTA 302 and mail filter 304. As described earlier, MTA 302 is adapted to send and receive electronic mails to and from other mail senders/receivers or relays 120/110 (internal or external to enterprise computing environment 100), and mail filter 304 is adapted to determine whether a received electronic mail is to be accepted or rejected.

For the embodiments, mail server 104 also includes one or more persistent storage units (or storage medium) 312, employed to stored management databases 202 and management data structures 212. Further, mail server 104 includes one or more processors and associated non-persistent storage (such as random access memory) 314, coupled to storage medium 312, to execute MTA 302 and mail filter 304.

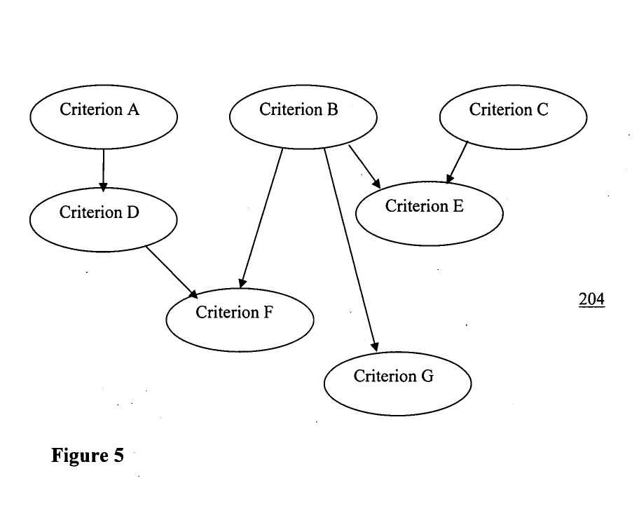

Having now described an example environment for practicing the present invention, we refer now to FIGS. 5-7 to further describe header analysis criteria 204, including its generation. As described earlier, in various embodiments, organized/compiled header analysis criteria 204 include independent and dependent header analysis criteria.

Examples of independent header analysis criteria may include

Rule big_message (10, 0)—which checks whether a message size parameter of the header of an electronic message indicates the message size of the electronic message is greater than a predetermined size, e.g., S kilobytes, and returns a positive evaluation result of e.g. good, if the message size of the electronic message is indeed determined to be greater than S kilobytes. Further, the rule specifies a score of 10 points to be accumulated into the positive scoring metric, when the evaluation result is positive.

Rule check_from_format (0, 70)—which checks whether a sender parameter of the header of an electronic message has syntactically correct recipient address(es), and returns a negative evaluation result of e.g., bad, if at least one syntactically incorrect recipient address is found. Further, the rule specifies a score of 70 points to be accumulated into the negative scoring metric, when the evaluation result is negative.

Rule has_disposition_notification_to (50, 0)—which checks whether the header of an electronic message includes a disposition notification, and returns a positive evaluation result of e.g., good, if a disposition notification is found. Further, the rule specifies a score of 50 points to be accumulated into the positive scoring metric, when the evaluation result is positive.

Rule has_habeas_haiku (100, 0)—which checks whether the header of an electronic message includes a Habeas Warrant Mark haiku, and returns a positive evaluation result of e.g., good, if a Habeas Warrant Mark haiku is found. Further, the rule specifies a score of 100 points to be accumulated into the positive scoring metric, when the evaluation result is positive.

Rule has_returnpath (0, 0)—which checks whether the header of an electronic message includes a return path, and returns a positive evaluation result of e.g., good, if a return path is found. Further, the rule specifies no score is to be accumulated to either the positive or the negative scoring metric.

Rule msg_dns_lookup (0, 0)—which checks whether all domain name service (DNS) lookups for server names extracted from the header of an electronic message have completed, and returns a positive evaluation result, e.g., good, if all DNS lookups have been completed. Further, the rule specifies no score is to be accumulated to either the positive or the negative scoring metric.

Rule received_date_check (0, 20)—which checks whether all received dates for server names extracted from the header of an electronic message are syntactically correct, and returns a negative evaluation result, e.g., bad, if at least one of the received dates is found to be syntactically incorrectly. Further, the rule specifies 20 points are to be accumulated to the negative scoring metric, if the evaluation result is negative. whether a message size parameter of the header of the electronic message indicates the electronic message as having a message size greater than a predetermined size threshold;

Examples of dependent header analysis criteria may include

Rule check_mailing_list (20, 0) requires
msg_dns_lookup completed
which checks whether the electronic message was sent to the recipient from a mailing list, using known mailing list software, and returns a positive evaluation result (e.g., Good), if the electronic message was sent to the recipient from a mailing list, using known mailing list software. Further, the rule specifies 20 points are to be accumulated to the positive scoring metric, if the evaluation result is positive.

Rule one_from_addr (0, 100) requires
msg_dns_lookup completed
check_mailing_list not good,
has_returnpath good,
check_from_format good
which checks whether the electronic message one From address in the header, or more than one, and returns a negative evaluation result (e.g., Bad), if the electronic message has more than one From address in the header. Further, the rule specifies 100 points are to be accumulated to the negative scoring metric, if the evaluation result is negative.

Note that in the above examples, the one_from_address analysis criterion, depends, among other things, on the check_mailing_list analysis criterion, which in turn, depends on the msg_dns_lookup analysis criterion.

Examples of header analysis criteria that check for bogus/counterfeit, and/or contradictory/inconsistent conditions are:

Rule check-bogus_XYZ_reply_to (0, 100) requires
check_from_format good
which checks for whether the address in the Replies To portion of a header claims to be an address of XYZ (e.g. Hotmail), yet the address is considered to be an illegal address of XYZ, and returns a negative evaluation result (e.g. Bad) if the inconsistency is detected. Further, the rule specifies 100 points are to be accumulated to the negative scoring metric, if the evaluation result is negative.

Rule direct_to_mx (0, 50) requires
sent_by_{—}1shoppingcart not good,
from_flonetwork not good,
aim_address_change not good,
msg_dns_lookup completed,
bounced_message not good,
has_habeas_haiku not good,
sender_check unknown,
check_mailing_list not good,
check_received_from_ip completed,
check_known_bulk_mailer unknown
which checks the message for signs that the message was transmitted directly to the destination's Mail Exchange (MX) server, without being handled first by any of the source mail hosts, and returns a negative evaluation result (e.g. Bad) if the signs are present. Further, the rule specifies 100 points are to be accumulated to the negative scoring metric, if the evaluation result is negative.

Rule forged_XYZ (0, 100) requires
from_XYZ bad
received_has_sender_domain not good;
which checks whether the domain XYZ appears in the domain portion of the source address, but XYZ does not appear in the Received line of the header, and returns a negative evaluation result (e.g. Bad) if the inconsistency is detected. Further, the rule specifies 100 points are to be accumulated to the negative scoring metric, if the evaluation result is negative.

FIG. 5 is a simplified example of an organized/compiled collection of header analysis criteria 204, in accordance with some embodiments. For the simplified example, header analysis criteria A, B and C are independent header analysis criteria, whereas header analysis criteria D, E, F and G are dependent header analysis criteria. In particular, header analysis criterion D depends on header analysis criterion A, header analysis criterion E depends on header analysis criteria B and C, header analysis criterion F depends on header analysis criteria B and D, and header analysis criterion G depends on header analysis criterion B.

Of course, as set forth in the provisional application, in practice, an implementation may include many more independent and dependent header analysis criteria.

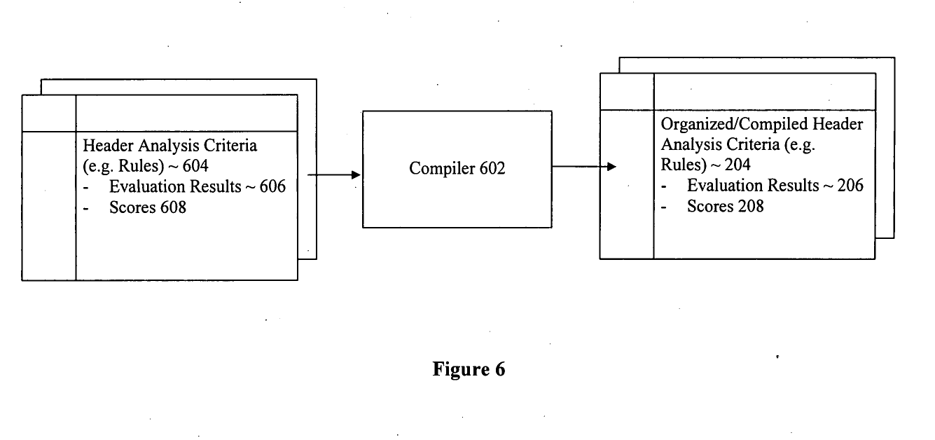

FIG. 6 illustrates an overview of the generation of a organized/compiled collection of header analysis criteria 204 (with expected evaluation results 206 and associated scores 208), in accordance with some embodiments. As illustrated embodiments, the organized/compiled collection of header analysis criteria 204 is compiled from a plurality of header analysis criteria specifications 604 (having expected evaluation results 606 and associated scores 608), using header analysis criteria compiler 602.

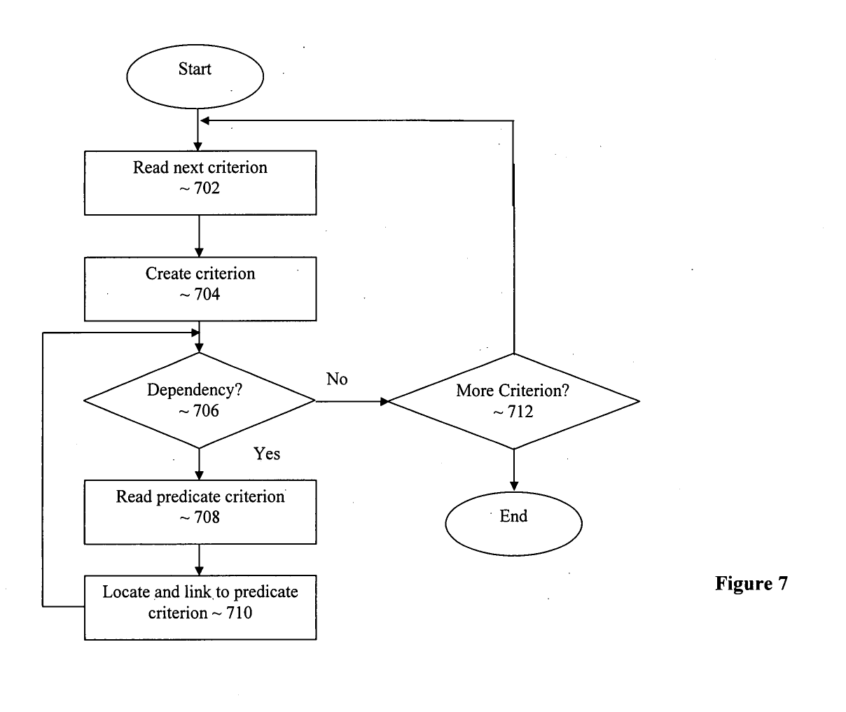

FIG. 7 illustrates the operational flow of header analysis criteria compiler 602 in further details, in accordance with some embodiments. As illustrated, for the embodiments, on start up, compiler 602 reads a next header analysis criterion, operation 702. On reading the next header analysis criterion, compiler 602 creates a record for the header analysis criterion read, operation 704.

Next, compiler 602 determines if the header analysis criterion read, has any unprocessed analysis dependency, operation 706. If so, compiler 602 reads the next predicate header analysis criterion, operation 708. On reading the next predicate header analysis criterion, compiler 602 locates and links the current the header analysis criterion to the predicate header analysis criterion, operation 710.

Thereafter, the compilation process returns to operation 706, where compiler 602 determines if the header analysis criterion read, has any unprocessed analysis dependency. Eventually, the result of the determination is negative. At such time, compiler 602 determines if there are more header analysis criteria to process. If so, the compilation process continues at operation 702, otherwise, the compilation process terminates.

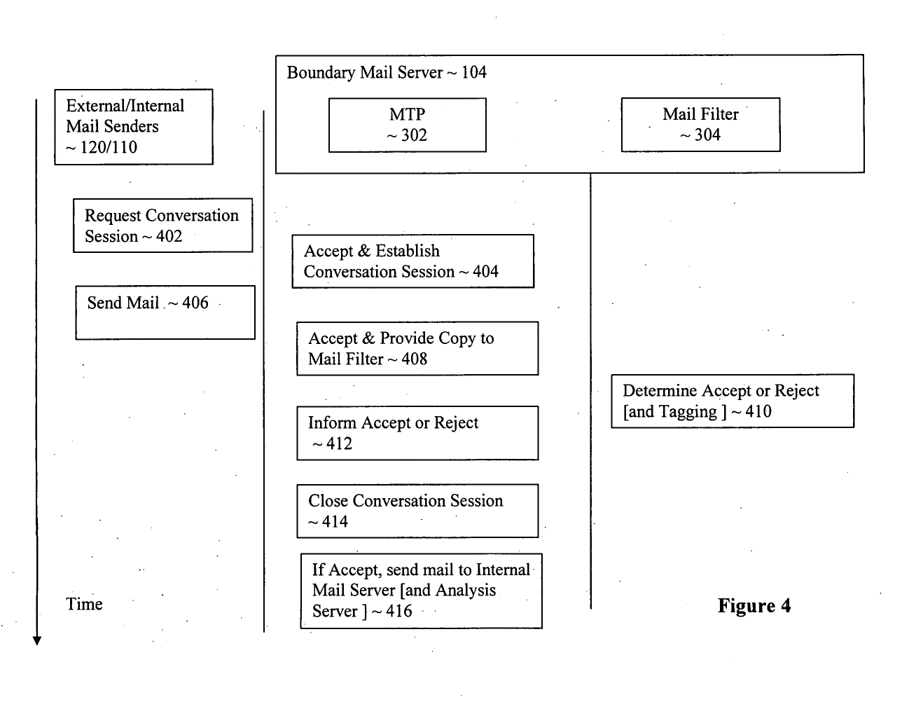

Having now also described the generation of the header analysis criterion, we refer to FIG. 4, wherein the operational flow of an external/internal mail sender 120/110 and a boundary mail server 104, in accordance to various embodiments, is shown. As illustrated, for the embodiments, the operations start with mail sender 120/110 requesting MTA 302 of the boundary mail server 104 to establish a conversation session, op 402. In response, MTA 302 accepts and establishes the conversation session, op 404.

Next, mail sender 120/110 sends the electronic mail through the conversation session, op 406, and MTA 302 accepts the electronic mail, and provides a copy of the received electronic mail to mail filter 304, to determine whether the electronic mail is to be accepted or rejected, op 408.

In response, mail filter 304 analyzes the header of the electronic mail, employing the independent and dependent header analysis criteria, as earlier described, op 410. For the embodiments, mail filter 304 further characterizes the electronic mail, based at least in part on the result of the header analysis, and makes an accept/reject determination for the electronic mail, op 410. In various embodiments, as described earlier, mail filter 304 performs the analysis, makes the characterization and determination, using the local copy of header analysis criteria.

Still referring to FIG. 4, for the illustrated embodiments, if analysis by an analyst or administrator is supported, mail filter 304 may further instruct MTA 302 to re-reroute or send an extra copy of the electronic mail to the analysis server (which may be the central management server 114). Thereafter, based on the determination results returned, including instructions, if any, MTA 302 informs mail sender 120/110 whether the electronic mail is accepted or rejected, op 412. Thereafter, MTA 302 closes the conversation session, op 414. In other words, for the embodiments, the accept/reject determination is performed during the conversation session, prior to its termination. The approach may have the advantage of ensuring an unwelcome or undesirable mail sender is aware of the rejection, potentially causing the unwelcome or undesirable mail sender to remove the recipient(s) from its recipient list.

Thereafter, if the electronic mail is to be accepted, MTA 302 forwards the electronic mail to the appropriate internal mail server 110, op 416. Further, if instructed, MTA 302 further sends a copy of the electronic message to an analysis server, e.g. mail management server 114, op 416.

In various embodiments, the electronic mail is provided from mail sender 120/110 to MTA 302 in parts, in particular, first an identification of the sender, followed by identifications of the recipients, and then the body of the electronic mail, and MTA 302 invokes mail filter 304 to determine acceptance or rejection of the electronic mail for each part. In other words, the electronic mail may be rejected after receiving only the identification of the sender, or after receiving identifications of the recipients, without waiting for the entire electronic mail to be provided. Again, the approach may have the advantage of efficient operation.

Accordingly, the electronic message management system 101 is particular suitable for managing unwelcome or undesirable electronic messages for an enterprise computing environment 100. System 101 enables the enterprise to manage the policies for electronic message management from a central location, which in turn enables the enterprise to manage electronic message acceptance/rejection uniformly, even if their equipment is geographically dispersed. Further, system 101 enables unwelcome or undesirable electronic messages to be rejected outright, lessening wasteful network traffic on the internal network.

Note that while for ease of understanding, most of the descriptions are presented in the context of an electronic mail provided by an external mail senders 120, as alluded to a number of times, embodiments of the present invention may be practiced to manage outbound electronic mails from internal mail senders 110, to uniformly enforce enterprise policies on preventing unauthorized or undesirable electronic mails from being sent outside enterprise computing environment 100.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. In particular, the earlier described header analysis needs not be performed as part of the conversation session, as described referencing FIG. 4. In various embodiments, the header analysis may be performed after the conversation session, that is “nominal” acceptance of the electronic message. This application is intended to cover any adaptations or variations of the embodiments discussed herein. Therefore, it is manifestly intended that this invention be limited only by the claims and the equivalents thereof.

1. An electronic message management system comprising:
a plurality of independent electronic message header analysis criteria, having no analysis dependence on other electronic message header analysis criteria;
a plurality of dependent electronic message header analysis criteria, each having one or more analysis dependency on one or more of the independent and other dependent electronic message header analysis criteria; and
a plurality of programming instructions adapted to analyze a header of an electronic message, employing the electronic message header analysis criteria.

2. The system of claim 1, wherein the plurality of independent and dependent electronic message header analysis criteria comprises a plurality of independent and dependent electronic message header analysis rules.

3. The system of claim 1, wherein the plurality of dependent electronic message header analysis criteria comprises a dependent electronic message header analysis criteria to be evaluated only after a selected one of the independent and other dependent electronic message header analysis criteria having been evaluated.

4. The system of claim 3, wherein the dependent electronic message header analysis criteria is to be evaluated only after the selected one of the independent and other dependent electronic message header analysis criteria having been evaluated with a particular evaluation result.

5. The system of claim 4, wherein the particular evaluation result is selected from the group consisting of a positive evaluation result, a non-positive evaluation result, a negative evaluation result, a non-negative evaluation result, a definitively eliminated evaluation result, an unable to eliminate evaluation result, and an unknown evaluation result.

6. The system of claim 1, wherein the plurality of dependent electronic message header analysis criteria comprises a dependent electronic message header analysis criteria that depends on a plurality other electronic message header analysis criteria that focus on a plurality of portions of the header, the plurality other electronic message header analysis criteria collectively detecting a counterfeit condition.

7. The system of claim 1, wherein the plurality of programming instructions are adapted to extract from the header of the electronic message, server name(s) of server(s) having handled the electronic message, and initiate domain name service lookup on the extracted server name(s).

8. The system of claim 1, wherein the plurality of programming instructions are adapted to first evaluate the independent electronic message header analysis criteria.

9. The system of claim 1, wherein
the plurality of independent and dependent electronic message header analysis criteria comprises a first independent or dependent electronic message header analysis criteria having a first associated score to be accumulated into a first scoring metric for the electronic message, if the independent or dependent electronic message header analysis criteria is evaluated with a first particular evaluation result; and
the programming instructions are adapted to accumulate the first associated score into the first scoring metric for the electronic message if the independent or dependent electronic message header analysis criteria is evaluated with the first particular evaluation result.

10. The system of claim 9, wherein the programming instructions are further adapted to characterize the electronic message based at least in part on the first scoring metric.

11. The system of claim 9, wherein
the plurality of independent and dependent electronic message header analysis criteria comprises a second independent or dependent electronic message header analysis criteria having a second associated score to be accumulated into a second scoring metric for the electronic message, if the independent or dependent electronic message header analysis criteria is evaluated with a second particular evaluation result;
the programming instructions are adapted to accumulate the second associated score into the second scoring metric for the electronic message if the independent or dependent electronic message header analysis criteria is evaluated with the second particular evaluation result; and
the programming instructions are further adapted to characterize the electronic message based at least in part on the first and second scoring metrics.

12. The system of claim 1, wherein the programming instructions are adapted to characterize the electronic message based at least in part on the result of the analysis.

13. The system of claim 1, wherein the plurality of electronic message header analysis criteria comprises one or more of
whether the header of the electronic message indicates a forged sender condition;
whether the header of the electronic message indicates a bogus reply to address; and
whether the header of the electronic message indicates a false direct provide to server representation.

14. The system of claim 1, wherein the plurality of independent electronic message header analysis criteria comprises one or more of
whether a message size parameter of the header of the electronic message indicates the electronic message as having a message size greater than a predetermined size threshold;
whether a sender parameter of the header of the electronic message includes at least one syntactically correct sender address;
whether the header of the electronic message includes Habeas Warrant Mark haiku;
whether all domain name service lookup(s) of server name(s) extracted from the header of the electronic message has/have been completed;
whether the header of the electronic message includes a disposition notification;
whether the header of the electronic message includes return path information; and
whether all received dates(s) associated with server name(s) extracted from the header of the electronic message is/are syntactically correct.

15. An electronic message management system comprising:
a plurality of electronic message header analysis criteria, each having at least a first and a second associated score to be accumulated into a first and a second scoring metric of an electronic message, which header is being analyzed, based at least in part on the electronic message header analysis criteria being evaluated with a first and a second particular result, respectively; and
a plurality of programming instructions adapted to analyze a header of an electronic message, employing the electronic message header analysis criteria, accumulate the first and second scores into the first and second scoring metrics of an electronic message, which header is being analyzed, accordingly, and characterize the electronic message, based at least in part on the first and second scoring metrics.

16. The system of claim 15, wherein the particular evaluation results are selected from the group consisting of a positive evaluation result, a non-positive evaluation result, a negative evaluation result, a non-negative evaluation result, a definitively eliminated evaluation result, an unable to eliminate evaluation result, and an unknown evaluation result.

17. The system of claim 15, wherein the plurality of electronic message header analysis criteria comprises one or more of
whether the header of the electronic message indicates a forged sender condition;
whether the header of the electronic message indicates a bogus reply to address; and
whether the header of the electronic message indicates a false direct provide to server representation.

18. The system of claim 15, wherein the plurality of electronic message header analysis criteria comprises one or more of
whether a message size parameter of the header of the electronic message indicates the electronic message as having a message size greater than a predetermined size threshold;
whether a sender parameter of the header of the electronic message includes at least one syntactically correct sender address;
whether the header of the electronic message includes Habeas Warrant Mark haiku;
whether all domain name service lookup(s) of server name(s) extracted from the header of the electronic message has/have been completed;
whether the header of the electronic message includes a disposition notification;
whether the header of the electronic message includes return path information; and
whether all received dates(s) associated with server name(s) extracted from the header of the electronic message is/are syntactically correct.

19. An electronic message management system comprising:
a plurality of electronic message header analysis criteria for evaluating a header of an electronic message, including at least whether the header of the electronic message includes a forgery, a bogus instruction, or a misrepresentation; and
a plurality of programming instructions adapted to analyze a header of an electronic message, employing the electronic message header analysis criteria.

20. The system of claim 19, wherein the plurality of electronic message header analysis criteria comprises a header analysis criteria of whether the header of the electronic message indicates a forged sender condition.

21. The system of claim 19, wherein the plurality of electronic message header analysis criteria comprises a header analysis criteria of whether the header of the electronic message indicates a bogus reply to address.

22. The system of claim 19, wherein the plurality of electronic message header analysis criteria comprises a header analysis criteria of whether the header of the electronic message indicates a false direct provide to server representation.

23. The system of claim 19, wherein the plurality of electronic message header analysis criteria further includes at least one of
whether a message size parameter of the header of the electronic message indicates the electronic message as having a message size greater than a predetermined size threshold,
whether a sender parameter of the header of the electronic message includes at least one syntactically correct sender address,
whether all domain name service lookup(s) of server name(s) extracted from the header of the electronic message has/have been completed,
whether the header of the electronic message includes a disposition notification,
whether the header of the electronic message includes return path information, and
whether all received dates(s) associated with server name(s) extracted from the header of the electronic message is/are syntactically correct.

24. A electronic message management method, comprising:
receiving an electronic message having a header; and
analyzing the header, first employing a plurality of independent electronic message header analysis criteria, having no analysis dependence on other electronic message header analysis criteria, and then employing a plurality of dependent electronic message header analysis criteria, each having one or more analysis dependency on one or more of the independent and other dependent electronic message header analysis criteria.

25. The method of claim 24, wherein each of the plurality of independent and dependent electronic message header analysis criteria has a first and a second associated score to be accumulated into a first and a second scoring metric for the electronic message, if the independent or dependent electronic message header analysis criteria is evaluated with a first and a second particular evaluation result, respectively, and the method further comprises
accumulating the first and second associated scores into the first and second scoring metric for the electronic message, accordingly; and
characterizing the electronic message based at least in part on the first and second scoring metrics.

26. A electronic message management method, comprising:
receiving an electronic message having a header;
analyzing the header, employing a plurality of electronic message header analysis criteria, each of the electronic message header analysis criteria having a first and a second associated score to be accumulated into a first and a second scoring metric for the electronic message, if the electronic message header analysis criteria is evaluated with a first and a second particular evaluation result, respectively; and
accumulating the first and second associated scores into the first and second scoring metric for the electronic message, accordingly.

27. The method of claim 26, wherein the method further comprises characterizing the electronic message based at least in part on the first and second scoring metrics.
